(19) United States
(12) Patent Application Publication
(10) Pub. No.: US 2002/0124136 A1
(43) Pub. Date: Sep. 5, 2002

(54) Portable storage system and method thereof

(75) Inventor: Yuan-Lung Chang, Taipei City (TW)

Correspondence Address: Ladas & Parry, 26 West 61st Street, New York, NY, 10023, US

(73) Assignee: COMJET INFORMATION SYSTEMS CORP.

(21) Appl. No.: 09/824,499

(22) Filed: Apr. 2, 2001

(30) Foreign Application Priority Data
Mar. 1, 2001 (TW) 90104696

(51) Int. Cl. G06F 12/00

(52) U.S. Cl. 711/113; 711/115

(57) ABSTRACT

The present invention discloses a portable storage system and method thereof used in a computer system. The present invention makes it easy to remove a mass storage device from a computer system without bumping against the operation system (OS). The portable storage system comprises a mass storage device, a processor, a first memory and a second memory. When a user removes the mass storage device from a computer system, the present invention can simulate a response to the OS in order to prevent the OS from shutting-down which will be caused if the OS cannot sense the existence of said mass storage device.

### FIELD OF THE INVENTION

The present invention relates to a portable storage system, more particularly, to transform the mass storage device of a computer into a portable storage system.

### BACKGROUND OF THE INVENTION

In the modem Internet age, mass information needs to be digitalized to proceed and store, and transmitted by computer. Thus the need for huge volume, high speed, portable and stabile recording media and storage devices for reading and writing the digitalized information is appreciated. Historically, portable storage systems have mostly used floppy disks; therefore the volume was greatly restricted. Recently, large volume portable storage systems such as CD-ROM or MO have been invented to provide greater storage capacity. However, because of their expensive price, consumers cannot afford to have such a portable storage system.

Presently, the cheapest and most convenient storage system is the hard disk. It does not have portability due to the restrictions of its design. Then, a removable box is designed to allow the hard disk to be easily removed from a computer. However, when we put a hard disk inside the removable box, we still cannot remove the hard disk from a computer while the computer OS is in operation. A function which we call a hot plug, allows users to remove disk units from a computer without turning off its power. Without this hot plug function, once the hard disk is removed from the computer, the OS will shut down because the CPU cannot sense the proper response of said hard disk. In addition, the use of a removable box often causes damage and instability to the computer system.

The Redundant Arrays of Inexpensive Disks (RAID) was proposed in the essay published by Patterson, Gibson and Katz of University of California at Berkeley, U. S. A. in 1987. RAID discloses the design of several disk arrays, whose purpose is to incorporate a plurality of small and inexpensive disks into a disk array. The performance of this disk array is better than some large but expensive disks. Further benefits of RAID includes such as: in spite of the combination of a plurality of disks when using RAID, it remains a single memory storage unit to the computer system using said RAID. RAID not only makes a backup easily, by a repetition storage method to implement the fault-tolerance function, but also has an easily removable feature to facilitate maintenance. Thus, a user can replace the broken disk without removing the whole disk system from the computer system. In order to get this function, RAID usually employs a removable box for the module design. This method puts each disk into a removable box from which the disk can connect to the computer system. This method also protects the refined structure of the disk (especially the hard disk.) However, if the conventional RAID design of the removable box supports the hot plug function, the main body of the RAID will also have a lock on each removable box to prevent the system from breakdown due to the plug action disrupting the connection of the disk in operation. With the increase in the number of the disk units being used in important application fields such as RAID of the telecommunication bureau, where the number of the disks is usually more than 100-200. If we try to replace one of the disks, it is very easy to cause the breakdown of the whole system because of difficulty of locating the disk to be replaced or due to the negligence of the computer operator. When there system breakdown, the transactions and services of the enterprise will be interrupted and important data will be lost. If, we sacrifice the convenience of hot plug function of the RAID to avoid the above problems, the RAID will become acceptable because of inconvenience and uselessness.

### SUMMARY OF INVENTION

The primary object of the present invention is to provide a portable storage system for a computer system. The portable storage system comprises a mass storage device, a processor, a first memory and a second memory. The system can simulates an appropriate response to a request from the OS when the mass storage device is removed from the computer. To simulate the existence of said mass storage device, the mass storage device can be provided with the hot plug function. Thus, a user can remove a mass storage device from a computer system at any time and use said mass storage device as a portable storage medium.

In addition, the present invention also provides an operation method of a portable storage system. Thus, a mass storage device (such as a hard disk) can be transformed into a portable storage medium.

### BRIEF DESCRIPTION OF THE DRAWINGS

FIG. 1 shows a basic structure block diagram of the present invention and how to connect it to a computer according to an embodiment of the present invention.

FIG. 2 shows the simulation of a hard disk to provide a response to the operation system in an embodiment of the present invention.

FIG. 3 shows the flow charts of the method of an embodiment in the present invention.

### LIST OF REFERENCE NUMERALS

(11) IDE bus

(12) Buffer cache memory

(13) EEPROM

(14) Processor

(15) IDE Disk 1

(16) IDE Disk 2

(21) IDE bus

(22) Buffer cache memory

(23) Buffer cache memory

(24) Mechanism Task

(25) Mechanism Task

(26) Physical data

(27) Physical data

(28) Processor

### DETAILED DESCRIPTION OF THE PREFERRED EMBODIMENT

The present invention provides a portable storage system for a computer system, which comprises a mass storage device; a first memory for buffering and storing the data necessary for responding to the instructions issued by the computer system to said mass storage device; a processor for receiving the instructions from the computer system to said mass storage device and responding preliminarily via said first memory to said computer system; and a second memory for storing programs necessary for the actions of the processor.

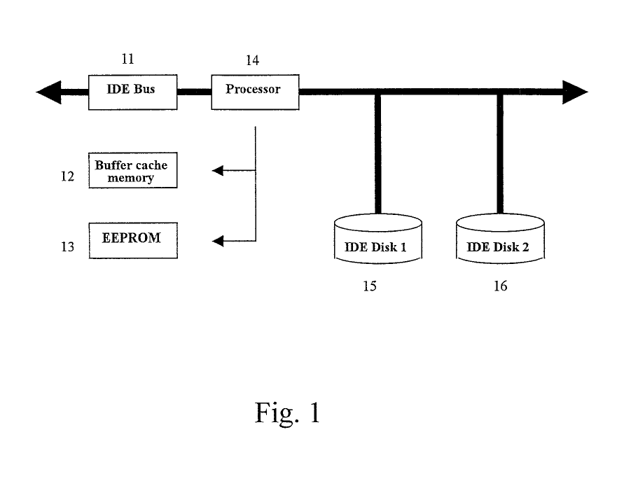

FIG. 1 is an embodiment of a portable storage system, used in such as a personal computer system, according to the present invention. The portable storage system comprises hard disks (15,16), a processor (14), a buffer cache memory (12) and an EEPROM (13). The system simulates an appropriate response to a request from the OS when the hard disk is removed from the computer. By simulating the existence of said hard disk, we can provide the function of a hot plug for all of the hard disks. Thus, a user can remove a hard disk from a PC at any time and use said hard disk as a portable storage medium. FIG. 1 provides a basic connection relationship of the present invention and IDE bus (11) with hard disks (15,16) of the computer system.

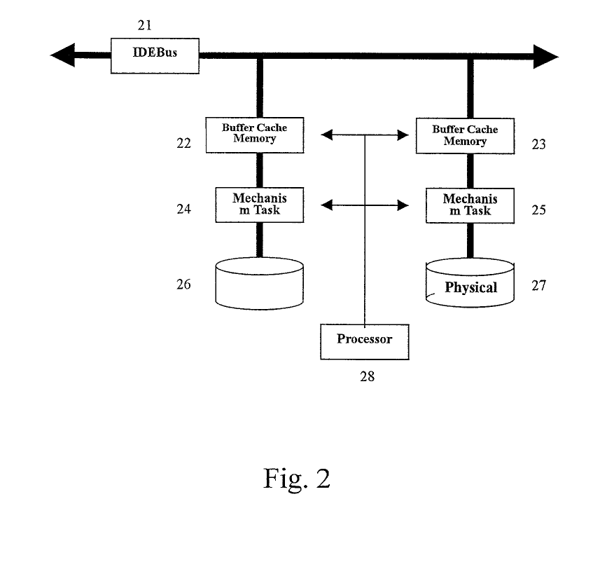

FIG. 2 shows the working theory of the portable storage system of the present invention, wherein a processor (28) is used for monitoring the hard disks (15,16) connected to the IDE bus. The system simulates an appropriate response to a request from the system CPU when the hard disk is removed from the computer. By simulating the existence of said hard disk, a user can remove a hard disk from a computer when the OS is in operation and thus, we can provide the function of a hot plug for all of hard disks. FIG. 2 shows how the embodiment of the present invention simulates the action as if the hard disk still exists and read/write the physical data (26,27) and performs the mechanism task (24,25) by a buffer cache memory (22,23). When the OS seeks a response from the hard disk which was removed, the processor (28) provides an appropriate response via said buffer cache memory (22,23) to prevent the system from shutting-down which will be caused if the OS cannot detect the existence of said hard disk.

Before the present invention, the way of responding the nonexistence of a hard disk by the OS is to determine the condition of the hard disk first. If said hard disk is not existed and cannot provide an appropriate response to the OS by a processor, the OS will be halted. Sometimes it will in result in the failure of a computer system.

If we can provide a response to the OS by a processor when the hard disk is not existed, then when a user reads/writes data to said hard disk, the processor will respond that the hard disk is not available. Thus, it will prevent the computer system from shutting-down.

In addition, the present invention also provides an operation method of a portable storage system. First, a processor receives the instructions of OS to a mass storage device; then, said processor will check the existence of said mass storage device and transmit the results to said OS via a buffer cache memory as a response. If said mass storage device is existed, said processor will perform the instructions of said OS on said mass storage device. In another embodiment of the present invention, if said response notes that said mass storage device is not existed, said OS will show the information of unavailability of said mass storage device on the display screen.

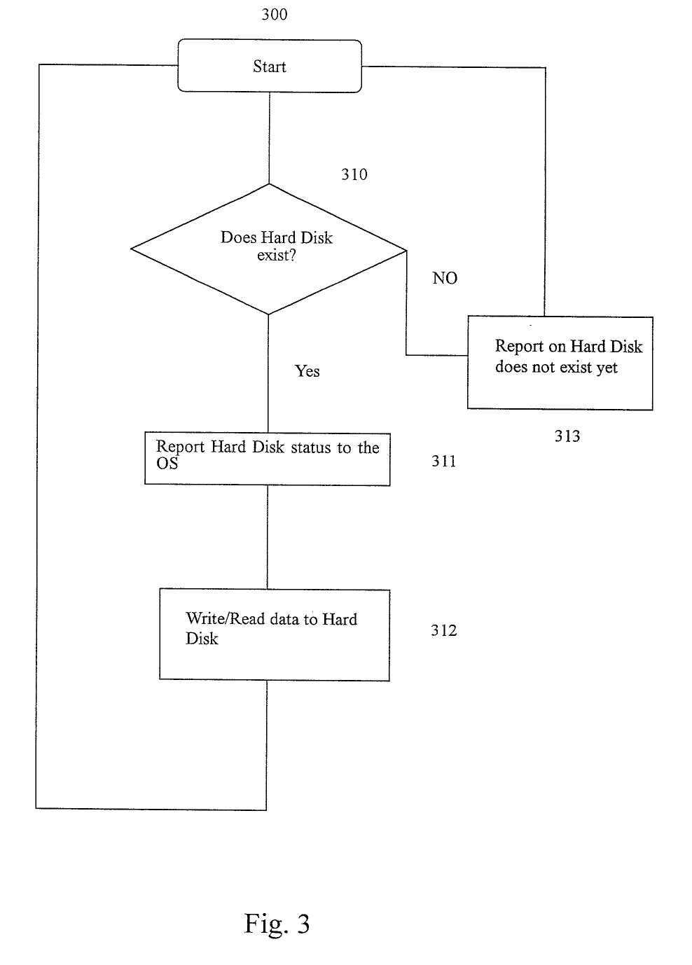

FIG. 3 shows the steps of the method using in an embodiment of the present invention. First, in the initial state (300), the OS will read the existence condition of the hard disks (310) and determine the hard disk, which will be removed, is existed or not. If said hard disk is not existed, the processor in an embodiment of the present invention will give OS a response that said hard disk is not existed (313). This will prevent the shutdown problem resulted from not responding to OS in the prior art. If said hard disk is existed, the processor in an embodiment of the present invention will give OS a response that said hard disk is currently available (311). At this time, the OS can read/write data to said hard disk.

Although the present invention has been disclosed in the preferred embodiment, it is not used to restrict the present invention. It should be appreciated by persons skilled in the art that changes and modifications may be made to the present invention without departing from the spirit and scope of the invention. Thus, the present invention is protected by the appended claims.

### REFERENCE

[1] Peter M. Chen, Edward K. Lee, Garth A. Gibson, Randy H. Katz and David A. Patterson, RAID: High-Performance, Reliable Secondary Storage, ACM Computing Surveys, Vol. 26, No. 2, June 1994

[2] Chris Ruemmler, John Wilkes: An Introduction to Disk Drive Modeling, IEEE Computer, Vol. 27, No. 3, March 1994

[3] D. A. Patterson, J.L. Hennessy: Computer Organization and Design—The Hardware/Software Interface, Morgan Kaufinan, San Mateo, Calif. 1998

[4] D. A. Patterson, J.L. Hennessy: Computer Architecture—A Quantitative Approach, Morgan Kaufinan, San Mateo, Calif., 1990

What is claimed is:

1. A portable storage system used in a computer system, comprising:
a mass storage device;
a first memory for buffering and storing data necessary for responding to the instructions of OS to said mass storage device;
a processor for receiving instructions of OS to said mass storage device and responding preliminarily to said OS via said first memory; and
a second memory for storing programs necessary for the actions of said processor.

2. The portable storage system of claim 1, wherein the first memory is a buffer cache memory.

3. The portable storage system of claim 1 or 2, wherein the second memory is an EEPROM.

4. A portable storage system used in a computer system, comprising:
a hard disk;
a first memory for buffering and storing data necessary for responding to the instructions of OS to said mass storage device;
a processor for receiving instructions of OS to said mass storage device and responding preliminarily to said OS via said first memory; and
a second memory for storing programs necessary for the actions of said processor.

5. The portable storage system of claim 4, wherein the first memory is a buffer cache memory.

6. The portable storage system of claim 4 or 5, wherein the second memory is an EEPROM.

7. A method of operating a portable storage system, comprising the following steps:
receiving instructions of OS to a mass storage device via a processor;
checking the existence of said mass storage device by said processor, and transmitting the results to OS via a buffer cache memory as a response; and
if said mass storage device is existed, said processor will perform the instructions of OS on said mass storage device.

8. The method of operating a portable storage system of claim 7, wherein the response noting that said mass storage device is not existed will cause said computer system to show on display screen the information that said mass storage device is not existed.

9. A method of operating a portable storage system, comprising the following steps:
receiving instructions OS to a hard disk via a processor;
checking the existence of said mass storage device by said processor, and transmitting the results to OS via a buffer cache memory as a response; and
if said mass storage device is existed, said processor will perform the instructions of OS on said mass storage device.

10. The method of operating a portable storage system of claim 9, wherein the response noting that said hard disk is not existed will cause the computer system to show on display screen the informaiton that said hard disk is not existed.
